(19) United States
(12) Patent Application Publication
(10) Pub. No.: US 2016/0118839 A1
(43) Pub. Date: Apr. 28, 2016

(54) WIRELESS CHARGING SYSTEM, WIRELESS CHARGING APPARATUS AND EMERGENCY IGNITION METHOD USING THE SAME

(71) Applicant: Hyundai Motor Company, Seoul (KR)

(72) Inventor: Jung Jun Lee, Seoul (KR)

(21) Appl. No.: 14/809,225

(22) Filed: Jul. 26, 2015

(30) Foreign Application Priority Data
Oct. 27, 2014 (KR) 10-2014-0146199

(51) Int. Cl. H02J 7/02; H02J 7/04

(52) U.S. Cl. CPC H02J 7/025; H02J 7/04

(57) ABSTRACT

A wireless charging system, a wireless charging apparatus, and an emergency ignition method using the same are disclosed herein. The wireless charging system includes: a fob of a smart key; a smart key unit registering authentication information of the fob and authenticating the fob based on the registered authentication information to control ignition of a vehicle; and a wireless charging apparatus driving a charging antenna coil to wirelessly charge the fob when the fob is positioned on a charging pad, receiving the authentication information of the fob through wireless power communication with the fob that is positioned on the charging pad when a request for the authentication information of the fob is received from the smart key unit upon discharging a battery of the fob, and providing the authentication information to the smart key unit.

### CROSS-REFERENCE TO RELATED APPLICATION

This application claims the benefit of and priority to Korean Patent Application No. 10-2014-0146199, filed on Oct. 27, 2014 in the Korean Intellectual Property Office, the disclosure of which is incorporated herein in its entirety by reference.

### TECHNICAL FIELD

The present disclosure relates generally to a wireless charging system, a wireless charging apparatus, and an emergency ignition method using the same, and more particularly, to a technology of controlling a stop state of a vehicle depending on a stop position of a school bus and a road environment.

### BACKGROUND

Generally, when a smart key system authenticates a fob, the smart key system registers information of the fob of a smart key in a smart key unit, exchanges information between the fob and the smart key unit while transmitting and receiving signals therebetween, and controls a door apparatus, an ignition apparatus, or the like. An antenna coil is typically present in an ignition button and is driven in a case in which a battery of the fob is discharged, thereby performing communication with a transponder positioned in the fob. The smart key unit receives information of the fob through the antenna coil of the ignition button to authenticate the fob.

However, the antenna coil provided in the ignition button only obtains the information of the fob and transfers the information to the smart key unit when the battery of the fob is discharged. To this end, the smart key unit should be separately provided with a module for converting a signal of the antenna coil.

### SUMMARY

The present disclosure has been made to solve the above-mentioned problems occurring in the prior art while advantages achieved by the related art are maintained intact.

An aspect of the present disclosure provides a wireless charging system, a wireless charging apparatus, and an emergency ignition method using the same capable of providing information for authentication of a fob and emergency ignition using a wireless charging apparatus provided in a vehicle in order to charge a battery of the fob.

According to embodiments of the present disclosure, a wireless charging system includes: a fob of a smart key; a smart key unit registering authentication information of the fob and authenticating the fob based on the registered authentication information to control ignition of a vehicle; and a wireless charging apparatus driving a charging antenna coil to wirelessly charge the fob when the fob is positioned on a charging pad, receiving the authentication information of the fob through wireless power communication with the fob that is positioned on the charging pad when a request for the authentication information of the fob is received from the smart key unit upon discharging a battery of the fob, and providing the authentication information to the smart key unit

The authentication information of the fob may be transmitted to the smart key unit through a controller area network (CAN) communication line connecting the smart key unit and the wireless charging apparatus to each other.

The authentication information of the fob may be identification (ID) information of the fob registered in the smart key unit

The smart key unit may authenticate the fob based on the authentication information of the fob received from the wireless charging apparatus to control emergency ignition of the vehicle.

Furthermore, according to embodiments of the present disclosure, a wireless charging apparatus includes: a CAN communicating unit transmitting or receiving signals to or from a smart key unit that authenticates a fob of a smart key to control ignition of a vehicle; a fob state confirming unit determine whether the fob is positioned on a charging pad when a request for authentication information of the fob for emergency ignition of the vehicle is received from the smart key unit; a wireless charging unit driving a charging antenna coil to perform wireless power communication when the fob is positioned on the charging pad and receiving the authentication information of the fob; and a controlling unit requesting the authentication information from the fob, which is communicably connected thereto through the wireless charging unit, and providing the authentication information of the fob received through the wireless charging unit to the smart key unit through the CAN communicating unit

The authentication information of the fob may be ID information of the fob registered in the smart key unit

The wireless charging apparatus may further include an output unit outputting a guide message for guiding the fob so as to be positioned on the charging pad when the fob is not positioned on the charging pad.

The wireless charging unit may wirelessly charge the fob by driving the charging antenna coil when a battery of the fob is discharged and the fob is positioned on the charging pad.

Furthermore, according to embodiments of the present disclosure, an emergency ignition method using a wireless charging apparatus includes: receiving a request for authentication information of a fob of a smart key for emergency ignition of a vehicle from a smart key unit that authenticates the fob to control ignition of the vehicle; determining whether the fob is positioned on a charging pad; driving a charging antenna coil, when the fob is positioned on the charging pad, to perform wireless power communication with the fob and to receive the authentication information of the fob; and transmitting the received authentication information of the fob to the smart key unit connected through a CAN communication line.

The authentication information of the fob may be ID information of the fob registered in the smart key unit

The emergency ignition method using a wireless charging apparatus may further include: outputting a guide message for guiding the fob so as to be positioned on the charging pad when the fob is not positioned on the charging pad.

The emergency ignition method using a wireless charging apparatus may further include: performing an authentication operation on the fob from the smart key unit based on the authentication information of the fob; and performing emergency ignition on the vehicle based on the performed authentication operation.

Furthermore, according to embodiments of the present disclosure, a non-transitory computer readable medium containing program instructions for performing an emergency ignition method using a wireless charging apparatus includes: program instructions that receive a request for authentication information of a fob of a smart key for emergency ignition of a vehicle from a smart key unit that authenticates the fob to control ignition of the vehicle; program instructions that determine whether the fob is positioned on a charging pad; program instructions that drive a charging antenna coil, when the fob is positioned on the charging pad, to perform wireless power communication with the fob and to receive the authentication information of the fob; and program instructions that transmit the received authentication information of the fob to the smart key unit connected through a CAN communication line.

The authentication information of the fob may be ID information of the fob registered in the smart key unit

The computer readable medium may further include: program instructions that output a guide message for guiding the fob so as to be positioned on the charging pad when the fob is not positioned on the charging pad.

The computer readable medium may further include: program instructions that perform an authentication operation on the fob from the smart key unit based on the authentication information of the fob; and program instructions that perform emergency ignition on the vehicle based on the performed authentication operation.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating a wireless charging system according to embodiments of the present disclosure.

FIG. 2 is a block diagram illustrating a configuration of the wireless charging apparatus according to embodiments of the present disclosure.

FIG. 3 is an illustrative view for describing a wireless power communication operation of the wireless charging apparatus according to embodiments of the present disclosure.

FIG. 4 is an illustrative view for describing an operation of a wireless charging system according to embodiments of the present disclosure.

FIG. 5 is a flow chart illustrating an operation flow of the wireless charging apparatus according to embodiments of the present disclosure.

### DETAILED DESCRIPTION OF THE EMBODIMENTS

It is to be noted that technical terms used in the present disclosure are used in order to describe specific exemplary embodiments and do not limit the present disclosure. In addition, unless indicated otherwise in the present disclosure, it is to be understood that all the technical terms used in the present disclosure are construed as meaning as those that are generally understood by those who skilled in the art rather than as excessively comprehensive meaning and excessively reduced meaning. In addition, when the technical terms used in the present disclosure are wrongly technical terms that do not accurately indicate the technical spirit of the present disclosure, it is to be understood that the terms are replaced with the technical terms understood by those skilled in the art. Further, the general terms used in the present disclosure must be understood according to the terms defined by the dictionary or the context and should not be excessively reduced meanings.

In addition, singular forms used in the present disclosure are intended to include plural forms unless the context clearly indicates otherwise. In the present disclosure, it is to be noted that the terms “configured of”, “including”, or the like, are not be construed as necessarily including several components or several steps described in the present disclosure and some of the above components or steps may not be included or additional components or steps are construed as being further included.

Terms including an ordinal number such as first, second, or the like, used in the present disclosure may be used to describe various components. However, these components are not limited to these terms. Terms are used only in order to distinguish one component from another component For example, the ‘first’ component may be named the ‘second’ component, and vice versa, without departing from the scope of the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit or controlling unit. The term “control unit” or “controlling unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control/controlling unit in conjunction with one or more other components, as would be appreciated by a person of ordinary skill in the art.

Hereinafter, embodiments of the present disclosure will be described in more detail with reference to the accompanying drawings. The same reference numerals will be used to describe the same or like components, independent of the reference numerals and an overlapped description of the same components will be omitted. Further, when it is decided that the detailed description of the known art related to the present disclosure may obscure the gist of the present disclosure, the detailed description thereof will be omitted. In addition, it is to be noted that the accompanying drawings are provided only in order to allow the spirit of the present disclosure to be easily understood and is to be interpreted as limiting the spirit of the present disclosure.

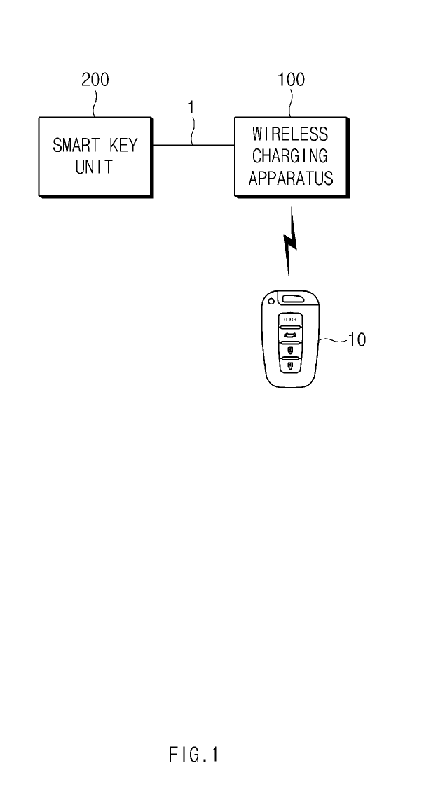

FIG. 1 is a view illustrating a wireless charging system according to embodiments of the present disclosure.

As shown in FIG. 1, the wireless charging system according to an exemplary embodiment of the present disclosure may be configured to include a fob 10 of a smart key, a wireless charging apparatus 100, and a smart key unit 200.

The smart key may be configured to include a key unit and the fob 10, and the fob 10 may perform communication with the smart key unit 200 to perform opening/closing of a vehicle door, vehicle ignition authentication, and the like.

The smart key unit 200, which is an apparatus managing all information associated with the fob 10, may transmit or receive signals to or from the fob 10, register information of the fob 10, and authenticate the corresponding fob 10 based on authentication information received from the registered fob 10 to control a door apparatus, an ignition apparatus, and the like, of a vehicle. In addition, the smart key unit 200 may be communicably connected to the wireless charging apparatus 100 provided in the vehicle to transmit or receive signals to or from the wireless charging apparatus 100. The smart key unit 200 may be communicatably connected to the wireless charging apparatus 100 through a vehicle network As an example, the smart key unit 200 may be communicatably connected to the wireless charging apparatus 100 through a controller area network (CAN) communication line 1.

The smart key unit 200 may request the wireless charging apparatus 100 to transfer the authentication information on the fob 10 in the case in which a battery of the fob 10 is discharged or a battery remaining amount is a reference value or less. The wireless charging apparatus 100 may perform wireless power communication with the fob 10 positioned on a charging pad by a request by the smart key unit 200, receive the authentication information from the fob 10, and transfer the authentication information to the smart key unit 200. Therefore, the smart key unit 200 receives the authentication information of the fob 10 from the wireless charging apparatus 100 and compares the authentication information with registered information to authenticate the corresponding fob 10. The smart key unit 200 may perform a requested operation when the authentication of the fob 10 is completed. As an example, the smart key unit 200 may control an operation of an ignition apparatus at the time of completing the authentication of the fob 10 to allow emergency ignition to be performed. In this case, even though the battery of the fob 10 is in a state in which it is discharged, the authentication of the fob 10 may be performed through the wireless charging apparatus 100, such that the emergency ignition is enabled.

The wireless charging apparatus 100 is provided in the vehicle and includes a charging antenna coil disposed therein. The wireless charging apparatus 100 drives the charging antenna coil when the fob 10 is positioned on the charging pad. The charging antenna coil generates power in an electromagnetic induction scheme to provide charging power to the fob 10 positioned on the charging pad. In addition, the wireless charging apparatus 100 may perform wireless power communication with the fob 10 using the charging antenna coil. The wireless charging apparatus 100 may perform the wireless power communication with the fob 10 when a request for the authentication information of the fob 10 by the smart key unit 200 is present. The wireless charging apparatus 100 may receive the authentication information from the fob 10 and transfer the authentication information to the smart key unit 200.

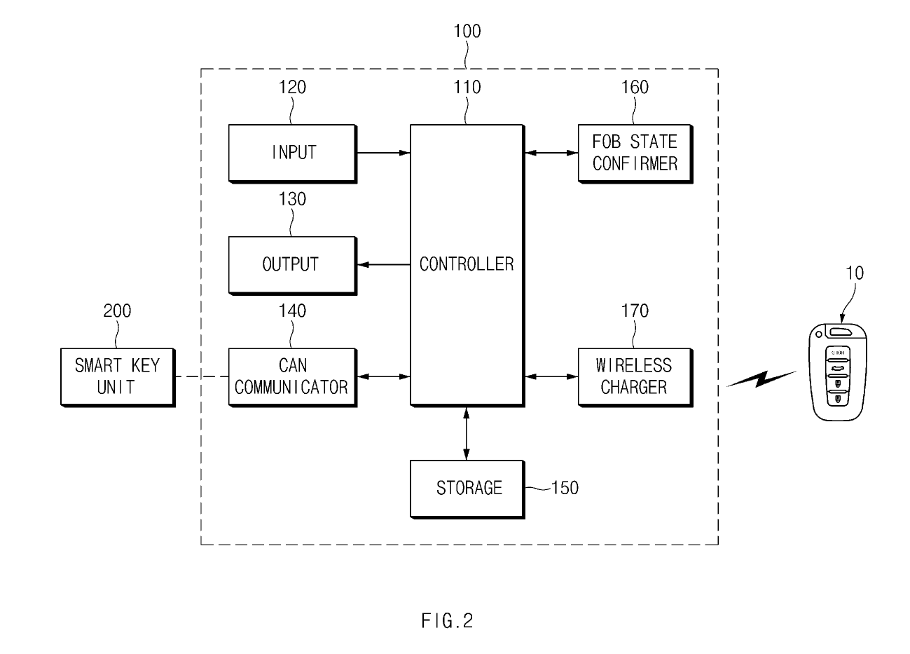

A detailed operation of the wireless charging apparatus 100 will be described in more detail with reference to FIG. 2.

FIG. 2 is a block diagram illustrating a configuration of the wireless charging apparatus according to embodiments of the present disclosure.

As shown in FIG. 2, the wireless charging apparatus 100 may be configured to include a controlling unit 110, an input unit 120, an output unit 130, a controller area network (CAN) communicating unit 140, a storing unit 150, a fob state confirming unit 160, and a wireless charging unit 170. The controlling unit 110 may control signals transferred between the respective units of the wireless charging apparatus.

The input unit 120, which is a unit receiving a control command input from a user, may be a key button implemented outside the wireless charging apparatus 100. In addition, the input unit 120 may also be a separate apparatus connected to the wireless charging apparatus 100 by a cable, or the like. The input unit 120 may be an input means such as a mouse, a joy stick, a jog shuttle, or a stylus pen.

The output unit 130 may include a display displaying an operation state, an operation result, and the like, of the wireless charging apparatus 100, and may include a speaker, a buzzer, or the like, outputting a guide message for guiding the fob 10 so as to be put on the charging pad. The display may display a battery remaining amount, a charging state, and the like, of the fob 10 at the time of performing wireless charging on the fob 10 on the charging pad. The display may be implemented in a touch screen form. The display may also be implemented in a form in which the input unit 120 and the output unit 130 are integrated with each other.

In addition, in the case in which the display includes a sensor sensing a touch operation, it may be used as an input apparatus in addition to an output apparatus. That is, in the case in which a touch sensor such as a touch film, a touch sheet, a touch pad, or the like, is provided in the display, the display may be operated as a touch screen. The display may include at least one of a liquid crystal display (LCD), a thin film transistor-liquid crystal display OFT LCD), an organic light-emitting diode (OLED), a flexible display, a field emission display (FED), and a 3D Display. In addition, the display may be a separate apparatus connected to the wireless charging apparatus 100 outside the wireless charging apparatus 100 or be an apparatus provided on an instrument panel of the vehicle.

The CAN communicating unit 140 may perform communication with electronic components and/or control units provided in the vehicle. As an example, the CAN communicating unit 140 may be communicatably connected to the instrument panel, the display, and the like, provided in the vehicle to transmit an operation state of the wireless charging apparatus 100 to the display. In addition, the CAN communicating unit 140 may be connected to the smart key unit 200 to receive a request for the authentication information of the fob 10, and may transmit the authentication information received from the fob 10, for example, ID information of the fob 10 to the smart key unit 200 in response to the request for the authentication information of the fob 10.

Although the CAN communicating unit 140 has been disclosed in embodiments of the present disclosure, a communicating unit may be implemented using a communication scheme connectable through a vehicle network, e.g., local interconnection network (LIN) communication, flex-ray communication, or the like.

The storing unit 150 may store a set value for an operation of the wireless charging apparatus 100 therein. As an example, the storing unit 150 may store a condition, an output value, and the like, for driving the charging antenna coil therein. In addition, the storing unit 150 may also store an algorithm for obtaining the authentication information from the fob 10 in response to a request of the smart key unit 200. The storing unit 150 may include at least one storing medium of a flash memory type memory, a hard disk type memory, a multimedia card micro type memory, a card type memory (for example, an SD memory, an XD memory, or the like), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM).

The controlling unit 110 may request the fob state confirming unit 160 to confirm a fob state in the case in which the request for the authentication information of the fob 10 is received from the smart key unit 200 through the CAN communicating unit 140. In this case, the fob state confirming unit 160 may decide whether the fob 10 is present on the charging pad. The fob state confirming unit 160 may confirm whether or not the fob 10 is present in various sensing schemes such as a touch sensing scheme, a proximity sensing scheme, a weight change sensing scheme, a power change sensing scheme, and the like. The controlling unit 110 may control an operation of the output unit 130 to output a guide message for guiding the fob 10 to be put on the charging pad, when it is confirmed from the fob state confirming unit 160 that the fob 10 is not present on the charging pad.

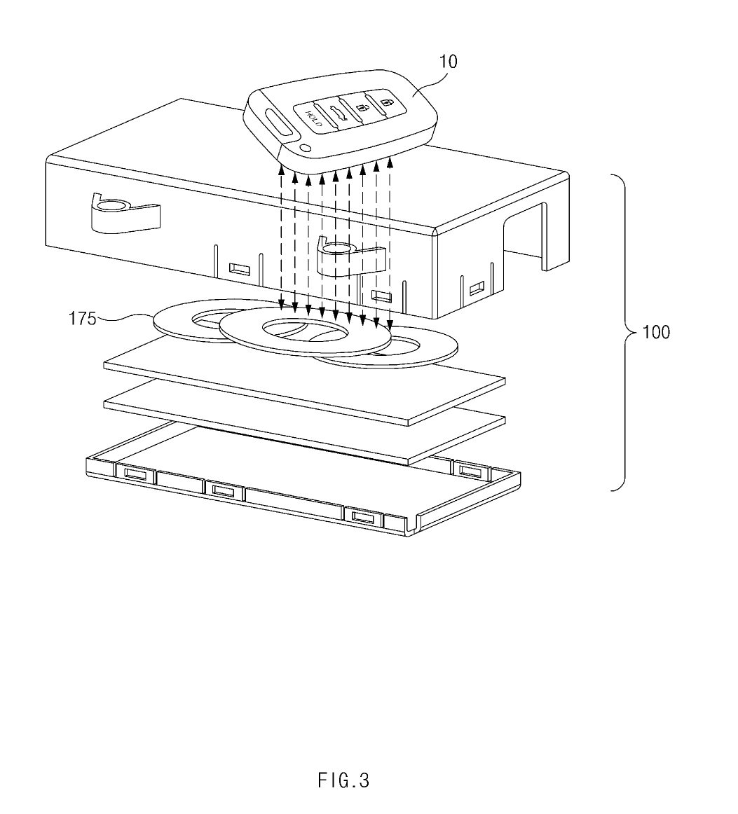

The wireless charging unit 170 drives the charging antenna coil 175 when the fob 10 is positioned on the charging pad. The charging antenna coil 175 generates charging power having a predetermined level, as illustrated in FIG. 3. The wireless charging unit 170 charges the battery of the fob 10 positioned on the charging pad using the charging power generated by the charging antenna coil.

Meanwhile, the controlling unit 110 may request the wireless charging unit 170 to perform communication with the fob 10 in the case in which the request for the authentication information of the fob 10 is received from the smart key unit 200 through the CAN communicating unit 140. The wireless charging unit 170 may perform wireless power communication with the fob 10 using the power generated by the charging antenna coil 175 of FIG. 3. In this case, the controlling unit 110 may request the fob 10 communicatably connected thereto through the wireless charging unit 170 to transmit the authentication information, and the wireless charging unit 170 may receive the authentication information from the fob 10 and transfer the authentication information to the controlling unit 110. The authentication information of the fob 10 may be identification (ID) information of the fob 10 registered in the smart key unit 200.

The controlling unit 110 allows the authentication information of the fob 10 received through the wireless charging unit 170 to be transmitted to the smart key unit 200 through the CAN communicating unit 140. Therefore, the smart key unit 200 performs an authentication operation on the corresponding fob 10 based on the authentication information of the fob 10 received through the CAN communicating unit 140 of the wireless charging apparatus 100 and controls emergency ignition of the vehicle depending on an authentication performing result for the fob 10.

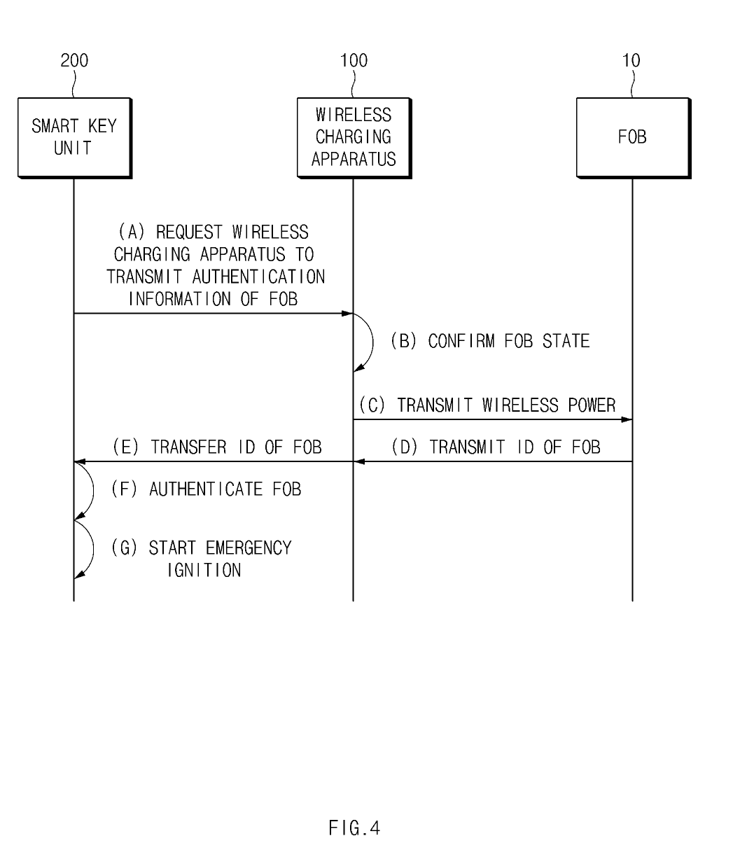

FIG. 4 is an illustrative view for describing an operation of a wireless charging system according to embodiments of the present disclosure.

As shown in FIG. 4, the smart key unit 200 may request the wireless charging apparatus 100 to transmit the authentication information of the fob for the purpose of the emergency ignition as in an operation (a). The wireless charging apparatus 100 may receive the request for the authentication information of the fob in a CAN communication scheme.

The wireless charging apparatus 100 confirms a state of the fob 10, i.e., whether or not the fob 10 is present on the charging pad as in an operation (b) for the purpose of wireless power communication with the fob 10. Once the fob 10 is positioned on the charging pad, the wireless charging apparatus 100 drives the charging antenna coil to transmit the wireless power having a predetermined level to the fob 10 as in an operation (c). In this case, the wireless charging apparatus 100 may request the fob 10 to transmit the authentication information.

The fob 10 may transmit the ID information thereof to the wireless charging apparatus 100 as in an operation (d) by the request of the wireless charging apparatus 100. In this case, the wireless charging apparatus 100 may transfer the ID information received from the fob 10 to the smart key unit 200 as in an operation (e). The wireless charging apparatus 100 may transfer the ID information of the fob 10 in the CAN communication scheme. The smart key unit 200 may compare the ID information of the fob 10 received from the wireless charging apparatus 100 and registered information with each other to authenticate the corresponding fob 10 as in an operation (f), and controls an ignition apparatus to start the emergency ignition as in an operation (g) when the authentication of the fob is completed.

An operation flow of the wireless charging apparatus according to the present disclosure configured as described above will be described below in detail.

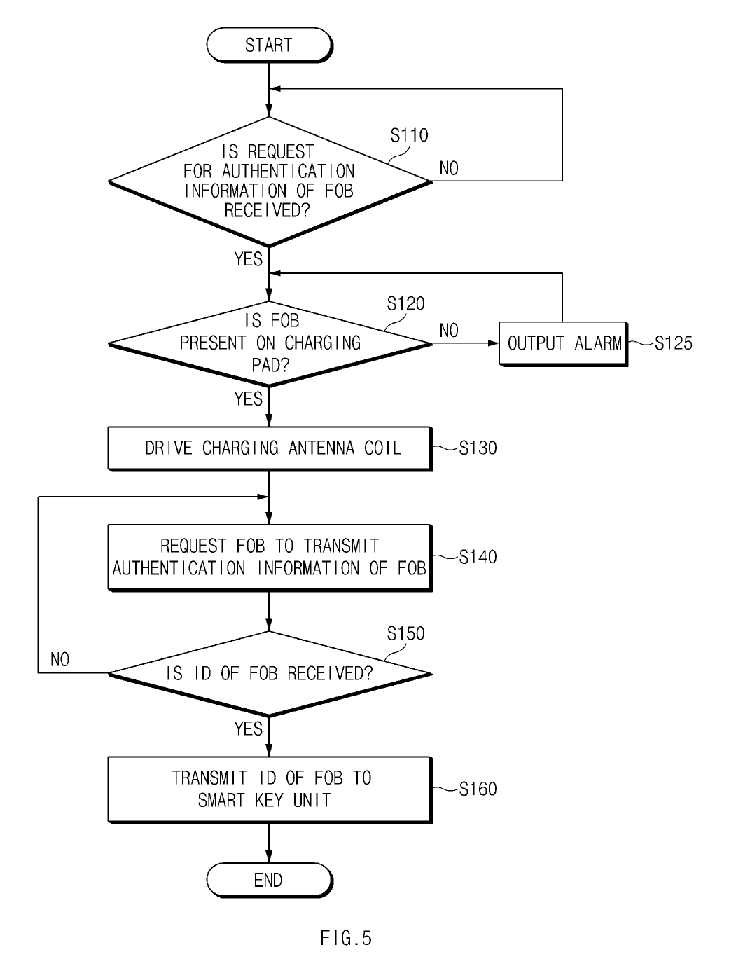

FIG. 5 is a flow chart illustrating an operation flow of the wireless charging apparatus according to embodiments of the present disclosure.

As shown in FIG. 5, the wireless charging apparatus decides whether the fob is present on the charging pad (S120) when the request for the authentication information on the fob is received from the smart key unit connected thereto through the CAN communication line (S110). When it is confirmed in S120 that the fob is not present on the charging pad, the wireless charging apparatus outputs an alarm (S125) to guide the fob so as to be put on the charging pad.

When the fob is positioned on the charging pad, the wireless charging apparatus drives the charging antenna coil (S130) to allow the power having the predetermined level to be generated from the charging antenna coil. The wireless charging apparatus is wireless-power-communicatably connected to the fob by the power generated by the charging antenna coil. In this case, the wireless charging apparatus requests the fob to transmit the authentication information (S140).

When the ID information is not received from the fob after S140, the wireless charging apparatus may again perform S140. Meanwhile, when the ID information is received from the fob (S150), the wireless charging apparatus transmits the ID information of the fob received in S150 to the smart key unit connected thereto through the CAN communication line (S160). When the ID information of the fob is transmitted to the smart key unit by the above-mentioned operation, the smart key unit authenticates the fob using the ID information of the fob. As a result, the smart key unit controls the emergency ignition of the vehicle.

As described above, according to embodiments of the present disclosure, since information for authentication of the fob and emergency ignition is provided using the wireless charging apparatus provided in the vehicle in order to charge the battery of the fob, a separate antenna coil does not need to be provided in an ignition button. Therefore, a separate module for recognizing a signal from the antenna coil does not need to be provided in the smart key unit. In addition, since the wireless charging and authentication information providing functions are performed using an existing wireless charging apparatus, the utilization of the wireless charging apparatus may be raised.

The above-mentioned processes may be directly implemented by hardware or software module executed by a processor or a combination thereof. The software module may reside in a random access memory (RAM), a flash memory, a read only memory (ROM), an erasable programming ROM (EPROM), an electrically erasable programming ROM (EEPROM), a register, a hard disk, a detachable disk, a storage medium such as a compact disk-ROM (CD-ROM), that is, a memory and/or a storage. An illustrative storage medium may be coupled to a processor, which may read information from the storage medium and write information to the storage medium. As another method, the storage medium and the processor may also be formed integrally with each other. The processor and the storage medium may also reside in an application specific integrated circuit (ASIC). The ASIC may also reside in a user terminal. As another method, the processor and the storage medium may also reside as individual components in the user terminal.

Hereinabove, although the present disclosure has been described by specific matters such as detailed components, and the like, embodiments, and the accompanying drawings, they have been provided only for assisting in the entire understanding of the present disclosure. Therefore, the present disclosure is not limited to the above-mentioned embodiments, but may be variously modified and altered by those skilled in the art to which the present disclosure pertains without departing from the spirit and scope of the present disclosure. Therefore, the present disclosure is not to be limited to the above-mentioned embodiments. That is, the following claims as well as all contents modified equally or equivalently to the claims are to fall within the scopes and spirits of the disclosure.

What is claimed is:

1. A wireless charging system comprising:
a fob of a smart key;
a smart key unit registering authentication information of the fob and authenticating the fob based on the registered authentication information to control ignition of a vehicle; and
a wireless charging apparatus driving a charging antenna coil to wirelessly charge the fob when the fob is positioned on a charging pad, receiving the authentication information of the fob through wireless power communication with the fob that is positioned on the charging pad when a request for the authentication information of the fob is received from the smart key unit upon discharging a battery of the fob, and providing the authentication information to the smart key unit.

2. The wireless charging system according to claim 1, wherein the authentication information of the fob includes identification (ID) information of the fob and is transmitted to the smart key unit through a controller area network (CAN) communication line connecting the smart key unit and the wireless charging apparatus to each other.

3. The wireless charging system according to claim 1, wherein the smart key unit authenticates the fob based on the authentication information of the fob received from the wireless charging apparatus to control emergency ignition of the vehicle.

4. A wireless charging apparatus comprising:
a CAN communicating unit transmitting or receiving signals to or from a smart key unit that authenticates a fob of a smart key to control ignition of a vehicle;
a fob state confirming unit determine whether the fob is positioned on a charging pad when a request for authentication information of the fob for emergency ignition of the vehicle is received from the smart key unit;
a wireless charging unit driving a charging antenna coil to perform wireless power communication when the fob is positioned on the charging pad and receiving the authentication information of the fob; and
a controlling unit requesting the authentication information from the fob, which is communicably connected thereto through the wireless charging unit, and providing the authentication information of the fob received through the wireless charging unit to the smart key unit through the CAN communicating unit.

5. The wireless charging apparatus according to claim 4, wherein the authentication information of the fob is ID information of the fob registered in the smart key unit.

6. The wireless charging apparatus according to claim 4, further comprising an output unit outputting a guide message for guiding the fob so as to be positioned on the charging pad when the fob is not positioned on the charging pad.

7. The wireless charging apparatus according to claim 4, wherein the wireless charging unit wirelessly charges the fob by driving the charging antenna coil when a battery of the fob is discharged and the fob is positioned on the charging pad.

8. An emergency ignition method using a wireless charging apparatus, comprising:
receiving a request for authentication information of a fob of a smart key for emergency ignition of a vehicle from a smart key unit that authenticates the fob to control ignition of the vehicle;
determining whether the fob is positioned on a charging pad;
driving a charging antenna coil, when the fob is positioned on the charging pad, to perform wireless power communication with the fob and to receive the authentication information of the fob; and
transmitting the received authentication information of the fob to the smart key unit connected through a CAN communication line.

9. The emergency ignition method using a wireless charging apparatus according to claim 8, wherein the authentication information of the fob is ID information of the fob registered in the smart key unit.

10. The emergency ignition method using a wireless charging apparatus according to claim 8, further comprising outputting a guide message for guiding the fob so as to be positioned on the charging pad when the fob is not positioned on the charging pad.

11. The emergency ignition method using a wireless charging apparatus according to claim 8, further comprising:
performing an authentication operation on the fob from the smart key unit based on the authentication information of the fob; and
performing emergency ignition on the vehicle based on the performed authentication operation.

12. A non-transitory computer readable medium containing program instructions for performing an emergency ignition method using a wireless charging apparatus, the computer readable medium comprising:
program instructions that receive a request for authentication information of a fob of a smart key for emergency ignition of a vehicle from a smart key unit that authenticates the fob to control ignition of the vehicle;
program instructions that determine whether the fob is positioned on a charging pad;
program instructions that drive a charging antenna coil, when the fob is positioned on the charging pad, to perform wireless power communication with the fob and to receive the authentication information of the fob; and
program instructions that transmit the received authentication information of the fob to the smart key unit connected through a CAN communication line.

13. The computer readable medium according to claim 12, wherein the authentication information of the fob is ID information of the fob registered in the smart key unit.

14. The computer readable medium according to claim 12, further comprising program instructions that output a guide message for guiding the fob so as to be positioned on the charging pad when the fob is not positioned on the charging pad.

15. The computer readable medium according to claim 12, further comprising:
program instructions that perform an authentication operation on the fob from the smart key unit based on the authentication information of the fob; and
program instructions that perform emergency ignition on the vehicle based on the performed authentication operation.
